(19) United States
(12) Patent Application Publication
(10) Pub. No.: US 2010/0063213 A1
(43) Pub. Date: Mar. 11, 2010

(54) GEL-PROCESSED POLYOLEFIN COMPOSITIONS

(76) Inventors: Glenn H. Fredrickson, Santa Barbara, CA (US); Edward Kramer, Santa Barbara, CA (US); Geoffrey W. Coates, Ithaca, NY (US)

Correspondence Address: BERLINER & ASSOCIATES, 555 WEST FIFTH STREET, 31ST FLOOR, LOS ANGELES, CA, 90013, US

(21) Appl. No.: 12/554,250

(22) Filed: Sep. 4, 2009

Related U.S. Application Data
(60) Provisional application No. 61/191,175, filed on Sep. 5, 2008.

(51) Int. Cl. C08F 10/00; C08F 110/06; C08L 23/00; B29C 47/00

(52) U.S. Cl. 525/240; 526/348.1; 525/191; 264/210.1; 264/210.7

(57) ABSTRACT

Semicrystalline polyolefins with narrow molecular weight distributions characterized by a low polydispersity index (PDI) and selected from the families of homopolymers, statistical copolymers, block copolymers, and graft copolymers, can be blended with a low molecular weight fluid diluent to create gel fiber and film compositions. These gel compositions, when subjected to mechanical or thermomechanical processing, either before or after removal of the diluent, result in fiber or film compositions that combine high tensile strength with other desirable physical properties, such as high rigidity, large extension at break, and/or high recoverable elasticity. These desirable combinations of properties are superior to those obtained from gel-processed semicrystalline polyolefins that are substantially similar in composition and molecular weight, but that have large PDIs.

### CROSS-REFERENCE TO RELATED APPLICATION

This application claims the benefit of U.S. Provisional Patent Application Ser. No. 61/191,175, filed Sep. 5, 2008 which is hereby incorporated by reference in its entirety.

### FIELD OF THE INVENTION

The present invention relates generally to the field of polymers. More particularly, it concerns semicrystalline polyolefins with narrow molecular weight distributions and which belong to the categories of homopolymers, statistical copolymers, block copolymers, or graft copolymers. The invention discloses that such low polydispersity index (PDI) materials, when used alone or in mixtures with conventional semicrystalline polyolefin materials and subjected to suitable “gel processing” methods, can be used to produce fiber and film with exceptional tensile strength and other desirable properties such as high modulus, high strain at break, and/or high recoverable elasticity. Said gel processing methods are known in the art to involve dilution of the polymer with a low molecular weight diluent to produce a gel composition that is subjected to mechanical or thermomechanical processing, either before or after the diluent is removed from the composition.

### BACKGROUND OF THE INVENTION

Polyolefins, such as various grades of polyethylene and polypropylene, constitute one of the most significant segments of the plastic materials market. Due to the low cost of the monomers (e.g. ethylene and propylene) and the versatility and ease of processing of the materials that can be created by polymerizing them, polyolefins have been widely adopted in a broad range of applications including packaging films and containers, pipes, liners, automotive plastics, wire and cable coatings, and injection and blow molded parts [J. A. Brydson, Plastic Materials (6^{th} Ed., Butterworth Heinemann, Oxford, 1995)].

In homopolymer form, polyethylene can either be highly crystalline and rigid, e.g. high-density polyethylene (HDPE), or of lower crystallinity but soft, tough, and flexible, as in low-density polyethylene (LDPE). The former consists largely of linear polyethylene (PE) chains, while the polymers in the latter are highly branched. Newer grades of polyethylene, such chains, while the polymers in the latter are highly branched. Newer grades of polyethylene, such as the metallocene PEs, are manufactured with catalysts and processes that exert more precise control over molecular weight distribution and degree and type of branching than the traditional HDPE and LDPE materials. Of particular relevance to this invention is ultra high molecular weight polyethylene (UHMWPE), which is a highly crystalline and high molecular weight form of HDPE. Commercial grades of both UHMWPE and HDPE are characterized by broad molecular weight distributions, defined here by a polydispersity index (PDI) that is significantly larger than 2.0. The PDI is known to those with skill in the art as the ratio of the weight-average molecular weight, M_{w}, to the number-average molecular weight, Mₙ, of the polymer as measured by well established methods such as gel permeation chromatography.

Similarly, many grades and types of polypropylene homopolymer (PP) exist in the marketplace. Because of the stereochemistry afforded by the pendant methyl groups along a PP chain, the types and properties of polypropylenes are more diverse than the case of polyethylene. For example, isotactic (iPP), syndiotactic (sPP), and atactic (aPP) polypropylenes are all manufactured commercially. Materials based on iPP and sPP tend to be more highly crystalline and rigid, while aPP materials are soft with low or no crystallinity. As with the case of PE, polypropylenes manufactured using different processes will differ in molecular weight distribution, degree of branching, processing behavior, and physical properties. The vast majority of commercial polypropylene materials are characterized by a PDI of greater than 2.0. Both PE and (tactic) PP materials are deemed “semi-crystalline”, since the long-chain nature of the molecules and their entanglement characteristics under both melt and solution conditions thwarts complete crystallization. While the solid state morphology of semi-crystalline polyolefins can vary widely and the crystals can adopt various forms, generally a two-region structure exists in which polymer chains connect and mechanically engage crystalline regions, which are separated by amorphous regions.

Olefinic monomers can also be copolymerized via a variety of chemical processes to create random or statistical copolymers. For example, copolymerizations of ethylene and propylene are used to make a rubbery material known as ethylene-propylene rubber (EPR). Small amounts of higher alpha-olefins, such as 1-hexene, or 1-octene, are also copolymerized with ethylene and propylene to create families of elastomeric, plastomeric, and semi-rigid semicrystalline polyolefin materials with a broad range of physical properties and applications.

While block and graft copolymers have been commercialized in other families of polymeric materials, most notably the styrenic block copolymers (SBCs) prepared by living anionic polymerization of styrenes, butadienes, and isoprenes, only recently have synthetic methods for producing polyolefin block and graft copolymers emerged. In the past decade, a variety of “living” alkene polymerization chemistries have been identified, which suppress chain termination and transfer processes so that precise control of molecular weight, molecular architecture, and stereochemistry can be achieved [G. J. Domski, J. M. Rose, G. W. Coates, A. D. Bolig, M. S. Brookhart, Prog. Polym. Sci. 32, 30-92 (2007).] By means of these catalyst systems and procedures, it is now possible to synthesize a wide variety of semi-crystalline polyolefin homopolymers, statistical copolymers, and block and graft copolymers with low PDIs of less than 2.0. For example, triblock copolymers with a linear A-B-A architecture have been prepared in which the A blocks are semicrystalline and either iPP or sPP, and the B blocks are amorphous (non-crystalline) statistical copolymers of ethylene and propylene with a low glass transition temperature (i.e. EPR). Such materials have been shown to have excellent elastomeric properties that are unique among thermoplastic polyolefins [A. Hotta, E. Cochran, J. Ruokolainen, V. Khanna, G. H. Fredrickson, E. J. Kramer, Y. -W. Shin, F. Shimizu, A. E. Cherian, P. D. Hustad, J. M. Rose, and G. W. Coates, Proc. Natl. Acad. Sci. 103, 15327 (2006).]

In 1979, P. Smith and coworkers [P. Smith, P. J. Lemstra, B. Kalb, and A. J. Pennings, Polymer Bull. 1, 733 (1979); P. Smith and P. J. Lemstra, Makromol. Chem. 180, 2983 (1979)] reported that UHMWPE homopolymer can be processed in solution using a diluent such as decalin to produce a gel fiber. Subsequent mechanical extension (drawing) and thermal treatment of the gel fiber, either before or after removal of the diluent, produced highly crystalline fibers or filaments with ultra-high strength and high modulus. The process was disclosed in U.S. Pat. Nos. 4,344,908 and 4,430,383 assigned to Stanicarbon, B.V. or DSM N.V. Similar disclosures for a broader range of semicrystalline polyolefin “substrates” and a broader range of process conditions were made in U.S. Pat. No. 4,413,110, U.S. Pat. No. 4,663,101, and U.S. Pat. No. 5,736,244 assigned to Allied, in U.S. Pat. No. 5,286,435 assigned to Bridgestone/Firestone, in U.S. Pat. No. 5,068,073 assigned to Akzo N.V., in U.S. Pat. No. 5,106,563 assigned to Mitsui, and in U.S. Pat. No. 7,344,668 assigned to Honeywell. However, none of these disclosures involved compositions containing narrow molecular weight distribution semicrystalline polyolefins with a PDI of less than 5.0.

In U.S. Pat. No. 4,436,189, Smith, Lemstra and coworkers disclose a process for achieving high strength and high modulus filaments from polyethylene homopolymer and polyethylene statistical copolymer substrates that have M_{w} greater than 400,000, have less than 5% incorporation of at least one alkene comonomers with 3-8 carbon atoms, and that have a PDI less than 5. However, these inventors did not disclose the use of substrates that contained one or more polyolefin block or graft copolymers or polypropylene polymers and copolymers, nor did they disclose the use of polyethylene homopolymer that contains up to 20% of ethylene units incorporated as branch units (due to chain walking) and a PDI of less than 5.0.

### BRIEF SUMMARY OF THE INVENTION

In this invention, we report that the gel processing technique developed by P. Smith, P. J. Lemstra and coworkers, which had heretofore only been applied to create rigid ultra high-strength fibers and film using polyolefin substrates with PDIs significantly greater than 2.0, could be used in connection with a variety of semicrystalline polyolefins with low PDIs to create unique materials that have exceptional tensile strength and a variety of other desirable physical properties that include, but are not limited to high modulus, high elongation at break, and/or high elastic recovery.

More specifically, semicrystalline polyolefins with narrow molecular weight distributions characterized by a low polydispersity index (PDI) and selected from the families of homopolymers, statistical copolymers, block copolymers, and graft copolymers, can be blended with a low molecular weight fluid diluent to create gel fiber and film compositions. These gel compositions, when subjected to mechanical or thermomechanical processing, either before or after removal of the diluent, result in fiber or film compositions that combine high tensile strength with other desirable physical properties, such as high rigidity, large extension at break, and/or high recoverable elasticity. These desirable combinations of properties are superior to those obtained from gel-processed semicrystalline polyolefins that are substantially similar in composition and molecular weight, but that have large PDIs.

1A. In an embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 2.0 and is a block copolymer, a graft copolymer, a homopolymer other than polyethylene, a polyethylene homopolymer with up to 20% of ethylene units incorporated as branch units, or a statistical polymer containing a majority of a monomer other than ethylene;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

In a more particularized embodiment of 1A, the film or fiber composition has high tensile strength, low strain at break, and high modulus.

In another particularized embodiment of 1A, the film or fiber composition has high tensile strength, high strain at break, and high recoverable elasticity.

In yet another particularized embodiment of 1A, the low PDI semicrystalline polyolefin is an A-B type block copolymer with semicrystalline A blocks and amorphous B blocks, and is an ABA triblock copolymer, an ABABA pentablock copolymer, a higher-order linear (AB)ₙ multiblock copolymer, or an (AB)ₙ radial block copolymer.

In another particularized embodiment of 1A, the low PDI semicrystalline polyolefin is an A-B type block or graft copolymer whose amorphous B polyolefin blocks or grafts have a glass transition temperature below the use temperature, and the crystals of the A polyolefin blocks or grafts melt at a temperature above the use temperature.

In still another particularized embodiment of 1A, the low PDI semicrystalline polyolefin is a homopolymer selected from the group consisting of syndiotactic polypropylene, isotactic polypropylene, polyethylene with up to 20% of the ethylene units incorporated as branches, isotactic poly(1-butene), syndiotactic poly(1-butene), isotactic or syndiotactic higher alpha-olefins including poly(1-hexene) or poly(1-octene); or isotactic or syndiotactic variants of poly(4-methyl-1-pentene), poly(3-methyl-1-butene), poly(4,4-dimethyl-1-pentene), or poly(vinylcyclohexane)

In another particularized embodiment of 1A, the low PDI semicrystalline polyolefin is an A-B type block or graft copolymer whose semicrystalline A blocks or grafts are selected from the group consisting of polyethylene, syndiotactic polypropylene, isotactic polypropylene, isotactic poly(1-butene), syndiotactic poly(1-butene), isotactic or syndiotactic higher alpha-olefins including poly(1-hexene) or poly(1-octene); or isotactic or syndiotactic variants of poly(4-methyl-1-pentene), poly(3-methyl-1-butene), poly(4,4-dimethyl-1-pentene), or poly(vinylcyclohexane).

In yet another particularized embodiment of 1A, the low PDI semicrystalline polyolefin is an A-B type block or graft copolymer whose amorphous B polymer blocks or grafts are polyolefins selected from the group consisting of atactic or regio-irregular polypropylenes; atactic poly(alpha-olefins) including poly(1-butene), poly(1-hexene), or poly(1-octene); polyolefin random or statistical copolymers selected from the group consisting of poly(ethylene-r-propylene), poly(ethylene-r-butene), poly(ethylene-r-pentene), poly(ethylene-r-hexene), poly(ethylene-r-heptene), poly(ethylene-r-isobutylene), and poly(ethylene-r-octene); or atactic or regio-irregular random or statistical copolymers formed by copolymerization of propylene with one or more higher alpha-olefins and with or without ethylene.

In another particularized embodiment of 1A, the low PDI semicrystalline polyolefin is an A-B type block or graft copolymer whose amorphous B polymer blocks are polyolefin compounds produced by hydrogenation of polyisoprenes, polybutadienes, or their random copolymers and wherein the semicrystalline A polymer blocks or grafts are polyolefin compounds produced by hydrogenation of polybutadiene.

In still another particularized embodiment of 1A, the low molecular weight fluid diluent is a low molecular weight liquid organic compound with low volatility such as a mineral oil, a paraffin oil, a plasticizer, a low volatility solvent, or a tackifier; or a low molecular weight organic compound with higher volatility such as decalin.

In another particularized embodiment of 1A, the low molecular weight fluid diluent is carbon dioxide in liquid, vapor or supercritical fluid form.

2A. In another embodiment, a method for producing a polymer gel fiber or film composition is provided, comprising:

mixing one or more semicrystalline polyolefins, at least one of the semicrystalline polyolefins having a low PDI of less than 2.0 and belonging to the categories of block copolymer, graft copolymer, homopolymer other than polyethylene, polyethylene homopolymer with up to 20% of ethylene units incorporated as branches, or statistical polymer containing a majority of a monomer other than ethylene, with one or more low molecular weight fluid diluents;

heating the mixture;

annealing the mixture;

shaping the mixture, either before or after the annealing step; and

cooling the mixture.

2B. In a particularized embodiment of 2A, further comprising a mechanical or thermomechanical step that converts the semicrystalline gel composition into a form in which the crystals are now of a suitable morphology to produce a fiber or film with high tensile strength and/or other desirable physical properties when the low molecular weight fluid diluent is removed.

2C. In yet another particularized embodiment of 2A or 2B, the mechanical or thermomechanical step is selected from the group consisting of simple extension in tension, repeated simple extension in tension and relaxation to zero stress where a larger maximum strain is reached on every cycle of extension and relaxation, biaxial extension, incremental biaxial extension and relaxation as in the simple tension example, extrusion of the material through a suitably shaped die or into a suitably shaped cavity, extrusion of the material through a die followed by application of stretching along the extrusion direction, extrusion of the material through a die followed by application of stretching along both the extrusion direction and the direction transverse to it; and deformation leading to a decrease in the thickness of the material by squeezing it between a set of rollers or any sequence of sets of rollers allowing a decrease in thickness, relaxation, a further decrease in thickness, relaxation and so on.

In another particularized embodiment of 2C, temperature changes would be imposed during or in between any of the steps of the process.

2D. In another particularized embodiment of 2A, further comprising removal of the low molecular weight fluid diluent, followed by a mechanical or thermomechanical step that converts the semicrystalline gel composition into a form in which the crystals are now of a suitable morphology to produce a fiber or film with high tensile strength and/or other desirable physical properties.

In another embodiment, a polymer compositions produced by the method disclosed in 2B above is provided.

In another embodiment, a polymer compositions produced by the method disclosed in 2D above is provided.

3A. In an embodiment, a method for producing a polymer gel fiber or film composition is provided comprising:

mechanically combining one or more semicrystalline polyolefins, at least one of the semicrystalline polyolefins having a low PDI of less than 2.0 and belonging to the categories of block copolymer, graft copolymer, homopolymer other than polyethylene, polyethylene homopolymer with up to 20% of ethylene units incorporated as branches, or statistical polymer containing a majority of a monomer other than ethylene, with one or more low molecular weight fluid diluents at elevated temperature using standard polymer processing equipment such as a compounder, mixer, or extruder; shaping into the desired form; and

cooling the mixture.

3B. In a particularized embodiment of 3A, further comprising a mechanical or thermomechanical step that converts the semicrystalline gel composition into a form in which the crystals are now of a suitable morphology to produce a fiber or film with high tensile strength and/or other desirable physical properties when the low molecular weight fluid diluent is removed.

3C. In a particularized embodiment of 3B, wherein the mechanical or thermomechanical step is selected from the group consisting of simple extension in tension, repeated simple extension in tension and relaxation to zero stress where a larger maximum strain is reached on every cycle of extension and relaxation, biaxial extension, incremental biaxial extension and relaxation as in the simple tension example, extrusion of the material through a suitably shaped die or into a suitably shaped cavity, extrusion of the material through a die followed by application of stretching along the extrusion direction, extrusion of the material through a die followed by application of stretching along both the extrusion direction and the direction transverse to it; and deformation leading to a decrease in the thickness of the material by squeezing it between a set of rollers or any sequence of sets of rollers allowing a decrease in thickness, relaxation, a further decrease in thickness, relaxation and so on.

In a particularized embodiment of 3C, wherein temperature changes would be imposed during or in between any of the steps of the process.

3D. In yet another particularized embodiment of 3A, further comprising removal of the low molecular weight fluid diluent, followed by a mechanical or thermomechanical step that converts the semicrystalline gel composition into a form in which the crystals are now of a suitable morphology to produce a fiber or film with high tensile strength and/or other desirable physical properties.

A polymer composition produced by the method disclosed in 3B above is provided.

A polymer composition produced by the method disclosed in 3D above is provided.

In another embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 3.0 and is a block copolymer, a graft copolymer, a homopolymer other than polyethylene, a polyethylene homopolymer with up to 20% of ethylene units incorporated as branch units, a statistical polymer containing a majority of a monomer other than ethylene, or an ethylene copolymer having greater than 5% incorporation of at least one alkene comonomer with 3-8 carbon atoms;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 3.0.

In yet another embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 5.0 and is a block copolymer, a graft copolymer, a homopolymer other than polyethylene, a polyethylene homopolymer with up to 20% of ethylene units incorporated as branch units, a statistical polymer containing a majority of a monomer other than ethylene, or an ethylene copolymer having greater than 5% incorporation of at least one alkene comonomer with 3-8 carbon atoms;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 5.0.

In still yet another embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 2.0 and is a block copolymer or a graft copolymer;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

In another embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 2.0 and is a homopolymer other than polyethylene;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

In yet another embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 2.0 and is a polyethylene homopolymer with up to 20% of ethylene units incorporated as branch units;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

In a further embodiment, a polymer film or fiber composition is provided comprising a mixture of one or more semicrystalline polyolefin polymers, wherein:

each semicrystalline polyolefin polymer is selected from the class of homopolymers, statistical copolymers, block copolymers, or graft copolymers;

at least one of the semicrystalline polyolefins in the mixture has a low PDI of less than 2.0 and is a statistical polymer containing a majority of a monomer other than ethylene;

said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

### DETAILED DESCRIPTION OF THE INVENTION

In accordance with the invention, at least one narrow molecular weight (low PDI) semicrystalline polyolefin that is either a block copolymer, a graft copolymer, a polypropylene homopolymer or statistical copolymer, or a homopolymer of polyethylene with up to 20% of ethylene units incorporated as branches, possibly in combination with other semicrystalline polyolefins, can be blended with one or more low molecular weight fluid diluents to create a gel composition. Said gel composition is formed into a fiber (filament) or film that is subjected to a mechanical or thermomechanical drawing process, either before or after the diluent is removed from the composition. The film or fiber composition that results from such gel processing can exhibit remarkable combinations of physical properties that combine high tensile strength with other desirable properties. These other desirable properties can be adjusted by controlling the architecture, molecular weight, and composition of the low PDI semicrystalline polymer substrate. For example, rigid film and fiber that combine high modulus and low extension at break with high tensile strength can be obtained by gel processing of a semicrystalline sPP, or iPP homopolymer with high melting point and PDI less than 2.0. Alternatively, elastic film and fiber that combine low modulus at low extension, high modulus at high extension, high tensile strength, and high elastic recovery, can be obtained by gel processing of a semicrystalline block copolymer with a PDI less than 2.0 and a triblock architecture such as PE-EPR-PE, sPP-EPR-sPP, or iPP-EPR-iPP, where EPR (ethylene-propylene rubber) is a statistical copolymer of ethylene and propylene that is substantially amorphous and has a low glass transition temperature. As another example, fiber or film with strain at break intermediate between a low PDI sPP homopolymer and a low PDI sPP-EPR-sPP triblock copolymer can either be obtained by blending the two polymers prior to gel processing, or by using an sPP-EPR-sPP triblock copolymer with a higher weight fraction of sPP. These examples are meant to be illustrative and not exhaustive. hi all cases, it should be understood that the desirable combinations of physical properties disclosed in this invention are enabled by gel processing of substrates that contain one or more low PDI semicrystalline polyolefins.

In one embodiment, a polymer composition is comprised of a mixture of one or more semicrystalline polyolefins, where

(i) each semicrystalline polyolefin is selected from the class of homopolymers, statistical copolymers, block copolymers, or graft copolymers,

(ii) at least one of the semicrystalline polyolefins in the mixture has a low PDI of less than 2.0 and is a block copolymer, a graft copolymer, a homopolymer other than polyethylene, a polyethylene homopolymer with up to 20% of ethylene units incorporated as branch units, or a statistical polymer containing a majority of a monomer other than ethylene, and

(iii) said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and

(iv) the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

In the case where the mixture of semicrystalline polyolefins contains one or more low PDI block or graft copolymers, each block or graft copolymer can be, but is not limited to, copolymers with semicrystalline A and amorphous B blocks, including an ABA triblock copolymer, an ABABA pentablock copolymer, a higher-order linear (AB)ₙ multiblock copolymer with n>1, an (AB)ₙ radial block copolymer with n>1; or a multiblock copolymer with architecture . . . ABABAB . . . , with block sizes and number of blocks per copolymer determined by a statistical process, and where the number average molecular weight of the A semicrystalline blocks is no less than 500 g/mole and the number average molecular weight of the B amorphous blocks is at least 1000 g/mole; or a graft copolymer comprised of an amorphous B backbone of number average molecular weight greater than 1000 g/mole to which is attached two or more grafts (branches) of semicrystalline polyolefin A, each of 500 g/mole or higher in number average molecular weight and placed regularly or randomly along the B backbone.

The semicrystalline A polymer blocks or grafts of the low PDI semicrystalline block or graft copolymers of the present invention are polyolefins that can be, but are not limited to, polyethylene, syndiotactic polypropylene, isotactic polypropylene, isotactic poly(1-butene), syndiotactic poly(1-butene), or isotactic or syndiotactic variants of poly(4-methyl-1-pentene), poly(3-methyl-1-butene), poly(4,4-dimethyl-1-pentene), or poly(vinylcyclohexane).

The amorphous B polyolefin blocks or grafts of the low PDI semicrystalline block or graft copolymers of the present invention can be, but are not limited to, atactic or regio-irregular polypropylenes; atactic poly(alpha-olefins) including poly(1-butene), poly(1-hexene), or poly(1-octene); polyolefin random or statistical copolymers selected from the group consisting of poly(ethylene-r-propylene), poly(ethylene-r-butene), poly(ethylene-r-pentene), poly(ethylene-r-hexene), poly(ethylene-r-heptene), poly(ethylene-r-isobutylene), and poly(ethylene-r-octene); atactic or regio-irregular random or statistical copolymers formed by copolymerization of propylene with one or more higher alpha-olefins and with or without ethylene; or polyolefin compounds produced by hydrogenation of polyisoprenes, polybutadienes, or their random copolymers.

The above mentioned low PDI semicrystalline polyolefins are defined here as those semicrystalline polyolefins that have number average molecular weights that can be preferably from 50,000-2,000,000 g/mole and more preferably from 200,000-1,000,000 g/mole. The polydispersity index or PDI, defined as the ratio of the weight average molecular weight, M_{w}, to the number average molecular weight, Mₙ, of each low PDI semicrystalline component, can be preferably from 1.01 to 5.0, more preferably from 1.01 to 3.0, even more preferably from 1.01 to 2.0, and most preferably from 1.01 to 1.5.

The low molecular weight fluid diluents used in the embodiments of the invention can be, but is not limited to, a low molecular weight organic compound with low volatility such as a mineral oil, a paraffin oil, a plasticizer, a low volatility solvent, a tackifier; a low molecular weight organic compound with higher volatility such as decalin; or carbon dioxide in liquid, vapor or supercritical fluid form. These low molecular weight fluid diluents can have molecular weights in the range of 10-5000 g/mole and preferably 10-1000 g/mole. The weight percentage of low molecular weight fluid diluents used in the gel compositions of the invention can be in the range of 15% to 99.9%, preferably in the range of 50% to 99.9%, and most preferably in the range of 80% to 99.9%.

The polymer gel film or fibers of this invention can be made by mixing one or more semicrystalline polyolefins and one or more low molecular weight fluid diluents; heating; annealing; shaping, forming, or extruding; and then cooling the mixture. Another procedure is to mechanically combine one or more semicrystalline polyolefins and one or more low molecular weight fluid diluents at elevated temperature using standard polymer processing equipment such as a compounder, mixer, or extruder.

A mechanical or thermomechanical process can convert the polymer gel fiber or film compositions formed by the above method, or the compositions produced by removing the diluent from the polymer gel compositions, into fiber or film with exceptional tensile strength and other desirable physical properties. Suitable mechanical processes can include, but are not limited to, simple extension in tension, repeated simple extension in tension and relaxation to zero stress where a larger maximum strain is reached on every cycle of extension and relaxation, biaxial extension, incremental biaxial extension and relaxation as in the simple tension example, extrusion of the material through a suitably shaped die or into a suitably shaped cavity, extrusion of the material through a die followed by application of stretching along the extrusion direction, extrusion of the material through a die followed by application of stretching along both the extrusion direction and the direction transverse to it, deformation leading to a decrease in the thickness of the material by squeezing it between a set of rollers or any sequence of sets of rollers allowing a decrease in thickness, relaxation, a further decrease in thickness, relaxation and so on. A suitable thermomechanical process is one that would impose temperature changes during or in between any of the steps of the mechanical processes outlined above.

### EXAMPLES

### Example 1

A syndiotactic polypropylene homopolymer (sPP) can be synthesized using the methods and catalysts described in J. Tian, P. D. Hustad, G. W. Coates, J. Am. Chem. Soc. 123, 5134-5135 (2001). The sPP homopolymer can have a weight average molecular weight of 500,000 g/mole and a PDI less than 2.0. The polymer can be dissolved at 5 wt % in a mineral oil diluent at elevated temperature to produce a clear liquid that upon cooling to room temperature produces a gel. A narrow strip, suitable for tensile testing, can be cut from the gel. The strip can be drawn in tension to a large extension ratio to create a gel fiber, and the mineral oil extracted in a hexane solution to produce a rigid sPP fiber. The fiber so obtained can have a high tensile modulus, a high tensile strength, and a small extension at break.

### Example 2

An sPP-EPR-sPP triblock copolymer, where the sPP end blocks are syndiotactic polypropylene and the middle block EPR is an amorphous ethylene-propylene random copolymer, can be synthesized using the methods and catalysts described in J. Tian, P. D. Hustad, G. W. Coates, J. Am. Chem. Soc. 123, 5134-5135 (2001). The triblock copolymer can have a weight average molecular weight of 350,000 g/mole and a PDI less than 2.0. The polymer can be dissolved at 5 wt % in a mineral oil diluent at elevated temperature to produce a clear liquid that upon cooling to room temperature produces a gel. A narrow strip, suitable for tensile testing, can be cut from the gel. The strip can be drawn in tension to a large extension ratio to create a gel fiber, and the mineral oil extracted in a hexane solution to produce an elastomeric sPP-EPR-sPP fiber. The fiber so obtained can have a low tensile modulus at low extension, a high tensile modulus at high extension, a high tensile strength, a large extension at break, and a high recoverable elastic strain.

1. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 2.0 and is a block copolymer, a graft copolymer, a homopolymer other than polyethylene, a polyethylene homopolymer with up to 20% of ethylene units incorporated as branch units, or a statistical polymer containing a majority of a monomer other than ethylene;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

2. The composition of claim 1, wherein the film or fiber composition has high tensile strength, low strain at break, and high modulus.

3. The composition of claim 1, wherein the film or fiber composition has high tensile strength, high strain at break, and high recoverable elasticity.

4. The composition of claim 1 wherein the low PDI semicrystalline polyolefin is an A-B type block copolymer with semicrystalline A blocks and amorphous B blocks, and is an ABA triblock copolymer, an ABABA pentablock copolymer, a higher-order linear (AB)ₙ multiblock copolymer, or an (AB)ₙ radial block copolymer.

5. The compositions of claim 1 wherein the low PDI semicrystalline polyolefin is an A-B type block or graft copolymer whose amorphous B polyolefin blocks or grafts have a glass transition temperature below the use temperature, and the crystals of the A polyolefin blocks or grafts melt at a temperature above the use temperature.

6. The compositions of claim 1 wherein the low PDI semicrystalline polyolefin is a homopolymer selected from the group consisting of syndiotactic polypropylene, isotactic polypropylene, polyethylene with up to 20% of the ethylene units incorporated as branches, isotactic poly(1-butene), syndiotactic poly(1-butene), isotactic or syndiotactic higher alpha-olefins including poly(1-hexene) or poly(1-octene); or isotactic or syndiotactic variants of poly(4-methyl-1-pentene), poly(3-methyl-1-butene), poly(4,4-dimethyl-1-pentene), or poly(vinylcyclohexane)

7. The compositions of claim 1 wherein the low PDI semicrystalline polyolefin is an A-B type block or graft copolymer whose semicrystalline A blocks or grafts are selected from the group consisting of polyethylene, syndiotactic polypropylene, isotactic polypropylene, isotactic poly(1-butene), syndiotactic poly(1-butene), isotactic or syndiotactic higher alpha-olefins including poly(1-hexene) or poly(1-octene); or isotactic or syndiotactic variants of poly(4-methyl-1-pentene), poly(3-methyl-1-butene), poly(4,4-dimethyl-1-pentene), or poly(vinylcyclohexane).

8. The compositions of claim 1 wherein the low PDI semicrystalline polyolefin is an A-B type block or graft copolymer whose amorphous B polymer blocks or grafts are polyolefins selected from the group consisting of atactic or regio-irregular polypropylenes; atactic poly(alpha-olefins) including poly(1-butene), poly(1-hexene), or poly(1-octene); polyolefin random or statistical copolymers selected from the group consisting of poly(ethylene-r-propylene), poly(ethylene-r-butene), poly(ethylene-r-pentene), poly(ethylene-r-hexene), poly(ethylene-r-heptene), poly(ethylene-r-isobutylene), and poly(ethylene-r-octene); or atactic or regio-irregular random or statistical copolymers formed by copolymerization of propylene with one or more higher alpha-olefins and with or without ethylene.

9. The compositions of claim 1 wherein the low PDI semicrystalline polyolefin is an A-B type block or graft copolymer whose amorphous B polymer blocks are polyolefin compounds produced by hydrogenation of polyisoprenes, polybutadienes, or their random copolymers and wherein the semicrystalline A polymer blocks or grafts are polyolefin compounds produced by hydrogenation of polybutadiene.

10. The compositions of claim 1 wherein the low molecular weight fluid diluent is a low molecular weight liquid organic compound with low volatility such as a mineral oil, a paraffin oil, a plasticizer, a low volatility solvent, or a tackifier; or a low molecular weight organic compound with higher volatility such as decalin.

11. The compositions of claim 1 wherein the low molecular weight fluid diluent is carbon dioxide in liquid, vapor or supercritical fluid form.

12. A method for producing a polymer gel fiber or film composition comprising:
mixing one or more semicrystalline polyolefins, at least one of the semicrystalline polyolefins having a low PDI of less than 2.0 and belonging to the categories of block copolymer, graft copolymer, homopolymer other than polyethylene, polyethylene homopolymer with up to 20% of ethylene units incorporated as branches, or statistical polymer containing a majority of a monomer other than ethylene, with one or more low molecular weight fluid diluents;
heating the mixture;
annealing the mixture;
shaping the mixture, either before or after the annealing step; and
cooling the mixture.

13. The method of claim 12, further comprising a mechanical or thermomechanical step that converts the semicrystalline gel composition into a form in which the crystals are now of a suitable morphology to produce a fiber or film with high tensile strength and/or other desirable physical properties when the low molecular weight fluid diluent is removed.

14. The method of claim 13, wherein the mechanical or thermomechanical step is selected from the group consisting of simple extension in tension, repeated simple extension in tension and relaxation to zero stress where a larger maximum strain is reached on every cycle of extension and relaxation, biaxial extension, incremental biaxial extension and relaxation as in the simple tension example, extrusion of the material through a suitably shaped die or into a suitably shaped cavity, extrusion of the material through a die followed by application of stretching along the extrusion direction, extrusion of the material through a die followed by application of stretching along both the extrusion direction and the direction transverse to it; and deformation leading to a decrease in the thickness of the material by squeezing it between a set of rollers or any sequence of sets of rollers allowing a decrease in thickness, relaxation, a further decrease in thickness, relaxation and so on.

15. The method of claim 14, wherein temperature changes would be imposed during or in between any of the steps of the process.

16. The method of claim 12, further comprising removal of the low molecular weight fluid diluent, followed by a mechanical or thermomechanical step that converts the semicrystalline gel composition into a form in which the crystals are now of a suitable morphology to produce a fiber or film with high tensile strength and/or other desirable physical properties.

17. The polymer compositions produced by the method of claim 13.

18. The polymer compositions produced by the method of claim 16.

19. A method for producing a polymer gel fiber or film composition comprising:
mechanically combining one or more semicrystalline polyolefins, at least one of the semicrystalline polyolefins having a low PDI of less than 2.0 and belonging to the categories of block copolymer, graft copolymer, homopolymer other than polyethylene, polyethylene homopolymer with up to 20% of ethylene units incorporated as branches, or statistical polymer containing a majority of a monomer other than ethylene, with one or more low molecular weight fluid diluents at elevated temperature using standard polymer processing equipment such as a compounder, mixer, or extruder; shaping into the desired form; and
cooling the mixture.

20. The method of claim 19, further comprising a mechanical or thermomechanical step that converts the semicrystalline gel composition into a form in which the crystals are now of a suitable morphology to produce a fiber or film with high tensile strength and/or other desirable physical properties when the low molecular weight fluid diluent is removed.

21. The method of claim 20, wherein the mechanical or thermomechanical step is selected from the group consisting of simple extension in tension, repeated simple extension in tension and relaxation to zero stress where a larger maximum strain is reached on every cycle of extension and relaxation, biaxial extension, incremental biaxial extension and relaxation as in the simple tension example, extrusion of the material through a suitably shaped die or into a suitably shaped cavity, extrusion of the material through a die followed by application of stretching along the extrusion direction, extrusion of the material through a die followed by application of stretching along both the extrusion direction and the direction transverse to it; and deformation leading to a decrease in the thickness of the material by squeezing it between a set of rollers or any sequence of sets of rollers allowing a decrease in thickness, relaxation, a further decrease in thickness, relaxation and so on.

22. The method of claim 21, wherein temperature changes would be imposed during or in between any of the steps of the process.

23. The method of claim 19, further comprising removal of the low molecular weight fluid diluent, followed by a mechanical or thermomechanical step that converts the semicrystalline gel composition into a form in which the crystals are now of a suitable morphology to produce a fiber or film with high tensile strength and/or other desirable physical properties.

24. The polymer compositions produced by the method of claim 20.

25. The polymer compositions produced by the method of claim 23.

26. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 3.0 and is a block copolymer, a graft copolymer, a homopolymer other than polyethylene, a polyethylene homopolymer with up to 20% of ethylene units incorporated as branch units, a statistical polymer containing a majority of a monomer other than ethylene, or an ethylene copolymer having greater than 5% incorporation of at least one alkene comonomer with 3-8 carbon atoms;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 3.0.

27. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 5.0 and is a block copolymer, a graft copolymer, a homopolymer other than polyethylene, a polyethylene homopolymer with up to 20% of ethylene units incorporated as branch units, a statistical polymer containing a majority of a monomer other than ethylene, or an ethylene copolymer having greater than 5% incorporation of at least one alkene comonomer with 3-8 carbon atoms;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 5.0.

28. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 2.0 and is a block copolymer or a graft copolymer;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

29. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 2.0 and is a homopolymer other than polyethylene;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

30. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 2.0 and is a polyethylene homopolymer with up to 20% of ethylene units incorporated as branch units;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.

31. A polymer film or fiber composition comprising a mixture of one or more semicrystalline polyolefin polymers, wherein:
each semicrystalline polyolefin polymer is selected from the class of homopolymers, statistical copolymers, block copolymers, or graft copolymers;
at least one of the semicrystalline polyolefins in the mixture has a low PDI of less than 2.0 and is a statistical polymer containing a majority of a monomer other than ethylene;
said polyolefin mixture is combined with one or more low molecular weight fluid diluents to produce a gel fiber or film that is subjected to a mechanical and/or thermomechanical deformation process, either before or after the one or more low molecular weight fluid diluents are removed from the composition; and
the resulting polymer film or fiber composition has exceptional tensile strength in combination with other desirable physical properties in comparison to film or fibers produced by similar gel processing steps with semicrystalline polyolefins of substantially similar composition and weight-average molecular weight, but where the PDI of all polymer components is greater than 2.0.
